(19) United States
(12) Patent Application Publication
(10) Pub. No.: US 2020/0272974 A1
(43) Pub. Date: Aug. 27, 2020

(54) QUALITY STABILIZATION SYSTEM AND QUALITY STABILIZATION METHOD

(71) Applicant: Yokogawa Electric Corporation, Tokyo (JP)

(72) Inventors: Keiji Sato, Tokyo (JP); Noboru Wakiyama, Tokyo (JP); Masayasu Ohashi, Tokyo (JP)

(73) Assignee: Yokogawa Electric Corporation, Tokyo (JP)

(21) Appl. No.: 16/794,751

(22) Filed: Feb. 19, 2020

(30) Foreign Application Priority Data
Feb. 26, 2019 (JP) 2019-033303

(51) Int. Cl. G06Q 10/06; G05B 23/02; G05B 19/418

(52) U.S. Cl. CPC G06Q 10/06395; G05B 19/41875; G05B 23/0254; G06Q 10/06393

(57) ABSTRACT

A quality stabilization system includes a design system unit and an execution system unit. The design system unit is configured to extract a feature amount indicating a time transition of operation data which is data related to a plurality of production elements of a product in a section in which there is likelihood of an influence on quality of the product from the operation data, generate an evaluation index, and define running maintenance improvement information from the evaluation index. The execution system unit is configured to monitor the operation data related to the product to be produced and supply reference information referred to in decision-making of a worker using the running maintenance improvement information when the execution system unit has detected that the quality of the product is likely to deviate from an allowable range of the evaluation index.

### BACKGROUND

### Technical Fields

The present invention relates to a quality stabilization system and a quality stabilization method capable of stabilizing quality of a product.

Priority is claimed on Japanese Patent Application No. 2019-033303, filed on Feb. 26, 2019, the contents of which are incorporated herein by reference.

### Related Art

In the related art, production systems such as process control systems are constructed in production fields such as plants or factories, and advanced automatic operations are realized. In production systems of the related art, conditions of production elements (elements used to produce a certain product) are set based on scientific technologies or production technologies established in laboratories, and quality of a product is guaranteed by keeping the set conditions. Here, among production elements, material, machine, method, and man are referred to as the “four elements of production.” The “four elements of production” are also referred to as 4M.

Japanese Unexamined Patent Application Publication No. 2016-177794 discloses a technology for specifying an inhibition factor that causes a variation in product performance and stabilizing product performance and manufacturing performance. Specifically, in the technology disclosed in Japanese Unexamined Patent Application Publication No. 2016-177794, lots of manufacturing processes are divided into a plurality of groups from scores of produced main components based on process data, superiority and inferiority of the plurality of groups are determined based on product data, inhibition factors contributing to the superiority and inferiority of the groups are specified, and the product performance and the manufacturing performance are stabilized.

Incidentally, variations in production elements have become considerable in recent years. In production systems of the related art, with regard to a variation in each production element, a burden on “Method” (substantially, control such as process control) among the “four elements of production” is suppressed forcibly. However, the variation in each production element has tended to increase, reaching levels at which an influence on quality of a product cannot be suppressed through only “Method.”

### SUMMARY

A quality stabilization system according to an aspect of the present invention may include a design system unit and an execution system unit. The design system unit may extract a feature amount indicating a time transition of operation data which is data related to a plurality of production elements of a product in a section in which there is likelihood of an influence on quality of the product from the operation data, generate an evaluation index for evaluating the quality of the product based on the feature amount, and define running maintenance improvement information necessary to estimate a cause of deterioration in the quality of the product and decide on measures for the production elements from the evaluation index. The execution system unit may monitor the operation data related to the product to be produced and supply reference information referred to in decision-making of a worker participating in production of the product using the running maintenance improvement information defined by the design system unit when the execution system unit has detected that the quality of the product is likely to deviate from an allowable range of the evaluation index.

Further features and aspects of the present disclosure will become apparent from the following detailed description of exemplary embodiments with reference to the attached drawings.

### BRIEF DESCRIPTION OF THE DRAWINGS

FIG. 1 is a block diagram illustrating a main unit configuration of a quality stabilization system according to an embodiment of the present invention.

FIG. 2A is a block diagram illustrating internal configurations of a performance ascertainer included in the design system unit.

FIG. 2B is a block diagram illustrating internal configurations of a KPI generator included in the design system unit.

FIG. 2C is a block diagram illustrating internal configurations of an OODA logic generator included in the design system unit.

FIG. 3 is a diagram illustrating examples of operation data sorted by a lot sorter of the performance ascertainer included in the design system unit.

FIG. 4A is a diagram illustrating a process executed by a feature amount extractor of the performance ascertainer included in the design system unit.

FIG. 4B is a diagram illustrating a process executed by a feature amount extractor of the performance ascertainer included in the design system unit.

FIG. 4C is a diagram illustrating a process executed by a feature amount extractor of the performance ascertainer included in the design system unit.

FIG. 5 is a diagram illustrating an example of a fault tree (FT) used in an embodiment of the present invention.

FIG. 6 is a diagram illustrating an example of an action list used in the embodiment of the present invention.

FIG. 7 is a diagram illustrating an example of an execution flowchart used in the embodiment of the present invention.

FIG. 8 is a flowchart illustrating an operation example of the quality stabilization system according to the embodiment of the present invention.

FIG. 9 is a flowchart illustrating details of a process executed in step S2 of FIG. 8.

FIG. 10 is a flowchart illustrating details of a process executed in step S3 of FIG. 8.

FIG. 11 is a block diagram illustrating an example of implementation of the quality stabilization system according to the embodiment.

### DETAILED DESCRIPTION OF THE EMBODIMENTS

The embodiments of the present invention will be now described herein with reference to illustrative preferred embodiments. Those skilled in the art will recognize that many alternative preferred embodiments can be accomplished using the teaching of the present invention and that the present invention is not limited to the preferred embodiments illustrated herein for explanatory purposes.

An aspect of the present invention is to provide a quality stabilization system and a quality stabilization method capable of stabilizing a quality of a product despite large variations in production elements.

Hereinafter, a quality stabilization system and a quality stabilization method according to an embodiment of the present invention will be described with reference to the drawings. Hereinafter, an overview of the embodiment of the present invention will be first described, and then the details of the embodiment of the present invention will be described.

### Overview

The embodiment is devised to stabilize quality of a product despite large variations in production elements. Here, examples of environs surrounding current production businesses include intensification of global competition, violent fluctuation of energy and material costs, decrease and aging of the working population, and diversification of supply chain irrespective of series. In such an environment, the following situations occur in production fields.
Quality of materials is no longer constant (Material).
Aging deterioration of machines is in progress (Machine).
Problems with methods that were not apparent before begin to emerge (Method).
In terms of personnel, running know-how is lost with the decrease in veteran staff (Man).

That is, in production fields, staff that lack know-how or experience have to produce products using materials of which quality varies and production machines that have deteriorated over time. Further, since products with higher quality than in the related art are requested, products differentiated in terms of higher quality than ever before have to be provided. Therefore, the present situation can be said to be a situation in which much labor is forced in production fields.

In production systems of the related art, with regard to a variation in each production element, a burden on “Method” (substantially, control such as process control) among the “four elements of production” is suppressed forcibly. However, the variation in each production element has tended to increase, reaching levels at which an influence on quality of a product cannot be suppressed through only “Method.”

Specifically, an example of an ethylene plant that produces petrochemical products such as ethylene will be described. With regard to “Material” which is one of the “four elements of production,” a composition of crude oil which is a material largely varies since the composition is diverse depending on a production area. With regard to “Machine,” it is difficult to change preset (installation) conditions in a short time during production of a product. With regard to “Method,” when tolerance of a change is higher than that of other production elements and is large, variations in the other production elements are absorbed. However, as the variations in the production become larger, it is difficult to absorb the variations completely.

With regard to “Man,” capability beyond the range of a manual depends on individual workers. That is, workers respond to problems based on, so to speak, tacit knowledge such as experience or intuition of the workers. When the workers are experienced and highly skilled, there is likelihood of variations in other production elements being suppressed. However, depending on the skill or the like of workers, there is concern of variations in other production elements not being suppressed, and thus predetermined production quality not being achieved.

Even if management items (for example, a liquid temperature, pH, immersion time, and the like) in “Method” are within ranges of management standard values, there is an influence of variations in other production elements when the variations in the other production elements are large. When there is such an influence, a variation in quality of a product for each production lot may increase, and thus there is concern of complaints from customers to whom products are delivered.

Here, there are individual countermeasures for variations in each element included in the “four elements of production.” However, states of other production elements while a product is being produced or relevance between the production elements is not known. Therefore, in the related art, there are problems that appropriate countermeasures are not taken in a timely manner and countermeasures are not taken in view of balance among the plurality of production elements.

In an embodiment of the present invention, a feature amount indicating a time transition of operation data which is data related to a plurality of production elements of a product in a section in which there is likelihood of an influence on quality of the product is first extracted from the operation data. Subsequently, an evaluation index for evaluating the quality of the product is generated based on the feature amount. Subsequently, running maintenance improvement information necessary to estimate a cause of deterioration in the quality of the product and decide on measures for the production elements from the evaluation index is defined. Then, the operation data related to the product which is being produced is monitored and reference information referred to in decision-making of a worker participating in production of the product is supplied using the defined running maintenance improvement information when it is detected that the quality of the product is likely to deviate from an allowable range of the evaluation index.

That is, in the embodiment of the present invention, relations among “quality of a product,” “variation in a production element,” and “an operation in a field” are found from previous running records (operation data) and running maintenance improvement information (an OODA logic) available for running in which states of variations in production elements in each method are added is defined. Then, the defined running maintenance improvement information is used to monitor and operate a plurality of production elements in real time in accordance with an OODA loop. The OODA loop is a loop in which observation (Observe), situation determination and orientation (Orient), decision-making (Decide), and action (Act) are set as elements. Thus, it is possible to stabilize quality of a product despite large variations in production elements.

Further, an objective of the embodiment is to provide a production system in which a user of a plant can ascertain a feature of the plant (knowledge-making) and accumulate improvement plans which can be applied under a specific running condition examined by the user as know-how (knowledge-collecting). The knowledge-making is “information indicating a state of production elements (4M or the like)” (ascertainment of facts) and the knowledge-making is “actual application of knowledge.”

### EMBODIMENT

### <Main Configuration of Quality Stabilization System>

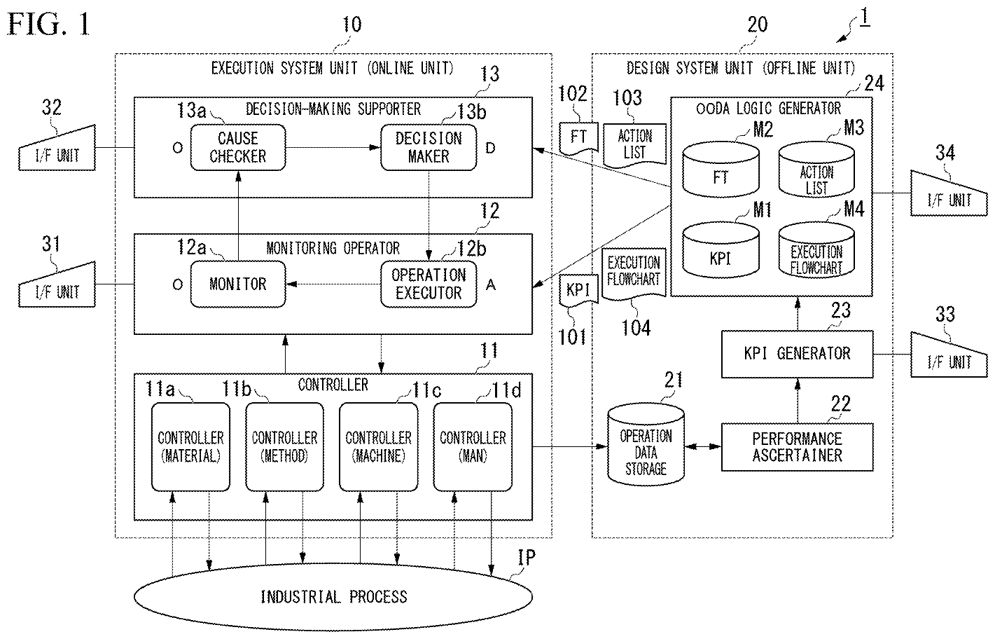

FIG. 1 is a block diagram illustrating a main unit configuration of a quality stabilization system according to an embodiment of the present invention. As illustrated in FIG. 1, a quality stabilization system 1 according to the embodiment is a system that includes an execution system unit 10 and a design system unit 20 and stabilizes quality of a product produced in an industrial process IP. The industrial process IP is a series of processes of producing a product (for example, a petrochemical product) from materials (for example, crude oil) (for example, including a separating process or a refining process using chemical reactions).

The execution system unit 10 controls the industrial process IP. The execution system unit 10 can be said to be an online unit because it controls the industrial process IP at all times. The design system unit 20 analyzes previous running records (operation data) and defines running maintenance improvement information (an OODA logic) necessary to estimate a cause of deterioration in quality of a product and decide on measures for the production elements. The design system unit 20 can be said to be an offline unit because it defines the OODA logic periodically or aperiodically (for example, about once a month).

Here, the OODA logic defined by the design system unit 20 includes a key performance indicator (KPI) 101, a fault tree (FT) 102, an action list 103, and an execution flowchart 104. The KPI 101 is an evaluation index used to evaluate quality of a product. The FT 102 is information that has a tree structure used for fault tree analysis (FTA) and is used to estimate a cause of deterioration in quality of a product. The action list 103 is a list used to decide on measures for the production elements. The execution flowchart 104 is a flowchart for automatically executing the measures for the production elements.

The OODA logic defined by the design system unit 20 is output to the execution system unit 10 and is used in the execution system unit 10 to stabilize quality of a product. Specifically, the OODA logic is used for the OODA loop that is realized by the execution system unit 10. The details of the OODA logic and the OODA loop will be described later.

Interfaces (I/Fs) 31 to 34 in the drawing function as interfaces between the quality stabilization system 1 and workers. That is, the interfaces 31 to 34 receive instructions of the workers to the quality stabilization system 1 or suggest various kinds of information of the quality stabilization system 1 to the workers. The interfaces 31 to 34 may include, for example, input devices such as keyboards or console panels or display devices such as liquid crystal display devices.

The execution system unit 10 includes a controller 11, a monitoring operator 12, and a decision-making supporter 13. The execution system unit 10 monitors operation data related to a product which is being produced and automatically executes control at regular times (normal times). When the execution system unit 10 detects that the quality of the product is likely to deviate from an allowable range of the KPI 101, the execution system unit 10 supplies reference information which is referred to in decision-making of a worker participating in production of products by using the OODA logic (specifically, the FT 102 and the action list 103) defined by the design system unit 20.

The controller 11 controls the production elements of products which are produced in the industrial process IP. Specifically, the controller 11 collects operation data which is data related to a plurality of production elements of the products which are produced in the industrial process IP and outputs the operation data to the monitoring operator 12 and the design system unit 20. An output timing of the collected operation data may differ for each production element. The controller 11 controls the plurality of production elements of the products which are produced in the industrial process IP based on an instruction from the monitoring operator 12. At this time, the control may be automatically executed using the OODA logic (specifically, the execution flowchart 104) defined by the design system unit 20.

The controller 11 includes four controllers 11a to 11d (control devices) corresponding to the “four elements of production.” The controller 11a controls “Material” among the “four elements of production.” The control of “Material” by the controller 11a can be executed in any method. For example, the controller 11a may execute control such that a mixture ratio (blend ratio) of materials used in the industrial process IP is changed. When a preprocessing device that preprocesses a material used in the industrial process IP is provided, the controller 11a may control the preprocessing device such that a variation in quality of the material is less. For example, when the material is crude oil, the controller 11a may control the preprocessing device such that viscosity of the crude oil is within a given range.

The controller 11b controls “Method” among the “four elements of production.” The controller 11b is, for example, a controller that is provided in a process control device such as a distributed control system (DCS). The controller 11b controls “Method” by controlling an actuator (a field device) installed on site in a plant in accordance with, for example, a measurement result of a sensor (a field device) installed on site in the plant. The controller 11b may execute control such that a running mode is switched in accordance with a material state. The running mode is a running condition in which a state of each of the production elements when a product is produced in the industrial process IP is added.

The controller 11c controls “Machine” among the “four elements of production.” The control of “Machine” by the controller 11c can be executed in any method. For example, when a washing function is provided in a machine used in the industrial process IP, the controller 11c may maintain constant machine performance (make a recovery from degradation of machine performance caused due to uncleanness of the machine), for example, by executing control such that the washing function is operated or notifying a person in charge of maintenance of a request for executing washing. The controller 11c may execute control such as a refueling interval of a driving system of the machine or a change in parameters in accordance with an aging situation of the machine in order to maintain constant machine performance.

The controller 11d controls “Man” among the “four elements of production.” The control of “Man” by the controller 11d may be executed in any method in accordance with the experience, skill, working form, or the like of the “Man.” For example, the controller 11d may execute scheduling for a worker who has low skill, such as association with a worker who has high skill as an assistant, so that a variation in skill of each worker does not occur. The controller 11d may control an operation timing of a worker, a change in a working sequence, or the like.

The monitoring operator 12 includes a monitor 12a and an operation executor 12b. The monitoring operator 12 monitors operation data output from the controller 11 and gives an instruction to the controller 11. The monitor 12a monitors the operation data output from the controller 11 at all times. When it is detected that the quality of a product obtained from the operation data is likely to deviate from the allowable range of the KPI 101 output from the design system unit 20, the monitor 12a outputs a warning signal indicating the detection to the decision-making supporter 13.

The operation executor 12b gives an instruction to each of the controllers 11a to 11d of the controller 11 so that the quality of the product produced in the industrial process IP is within the allowable range of the KPI 101 output from the design system unit 20. The operation executor 12b may give an instruction according to an instruction from a worker input through the interface 31 to the controllers 11a to 11d. Alternatively, the operation executor 12b may automatically give an instruction according to the execution flowchart 104 supplied from the design system unit 20 to the controllers 11a to 11d.

The decision-making supporter 13 includes a cause checker 13a and a decision maker 13b. When the warning signal is output from the monitor 12a of the monitoring operator 12, the decision-making supporter 13 supplies reference information which is referred to in the decision-making of the worker based on the OODA logic (specifically, the FT 102 and the action list 103) output from the design system unit 20. The cause checker 13a estimates a cause of deterioration in the quality of the product (a cause of the deviation in the quality of the product from the allowable range of the KPI 101 output from the design system unit 20) using the FT 102 output from the design system unit 20. The cause estimated by the cause checker 13a may be displayed on, for example, the interface 32.

The decision maker 13b supplies the reference information which is referred to in the decision-making of the worker based on the action list 103 output from the design system unit 20. The reference information supplied from the decision maker 13b may be displayed on, for example, the interface 32. The decision maker 13b may cause the operation executor 12b of the monitoring operator 12 to execute the execution flowchart 104 supplied from the design system unit 20.

Here, in the execution system unit 10, the OODA loop is realized by the monitoring operator 12 and the decision-making supporter 13. Specifically, “observation (Observe)” is realized by the monitor 12a of the monitoring operator 12, “situation determination or orientation (Orient)” is realized by the cause checker 13a of the decision-making supporter 13, “decision-making (Decide)” is realized by the decision maker 13b of the decision-making supporter 13, and an “action (Act)” is realized by the operation executor 12b of the monitoring operator 12.

The design system unit 20 includes an operation data storage 21, a performance ascertainer 22 (extractor), a KPI generator 23 (evaluation index generator), and an OODA logic generator 24 (definer). The design system unit 20 extracts a feature amount indicating a time transition of the operation data in a section in which there is likelihood of an influence on quality of a product from the operation data which is data related to the plurality of production elements of the product, generates the KPI 101 for evaluating the quality of the product based on the feature amount, and defines the OODA logic (the KPI 101, the FT 102, the action list 103, and the execution flowchart 104) necessary to estimate a cause of deterioration in the quality of the product and decide on measures for the production elements from the evaluation index.

The operation data storage 21 stores the operation data output from the controller 11 of the execution system unit 10. The operation data storage 21 is realized by, for example, an external storage device such as a hard disk. The performance ascertainer 22 extracts a feature amount indicating a time transition of the operation data in a section in which there is likelihood of an influence on quality of a product from the operation data stored in the operation data storage 21. The KPI generator 23 generates the KPI 101 which is an evaluation index for evaluating the quality of the product based on the feature amount extracted from the performance ascertainer 22. The OODA logic generator 24 defines the OODA logic necessary to estimate a cause of deterioration in the quality of the product and decide on measures for the production elements from the KPI 101 generated by the KPI generator 23.

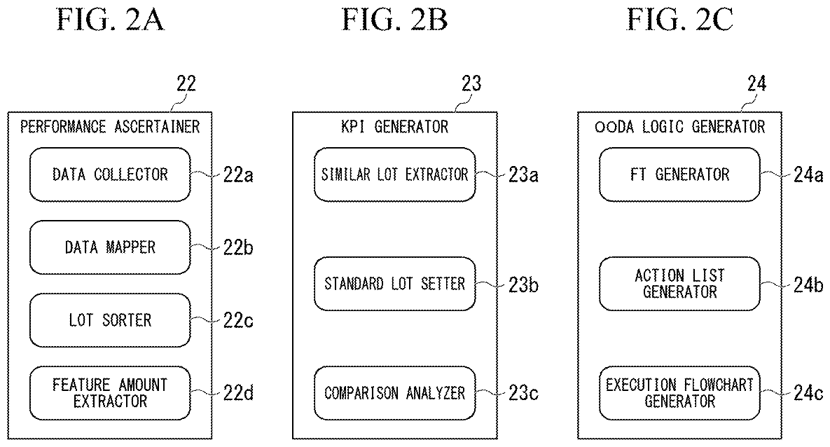

FIGS. 2A to 2C are block diagrams illustrating internal configurations of the performance ascertainer, the KPI generator, and the OODA logic generator included in the design system unit. As illustrated in FIG. 2A, the performance ascertainer 22 includes a data collector 22a, a data mapper 22b, a lot sorter 22c, and a feature amount extractor 22d.

The data collector 22a collects the operation data stored in the operation data storage 21. Specifically, the data collector 22a reads the operation data of each production element stored in the operation data storage 21 and associates the read operation data so that the read operation data is data in the same time zone to store the read operation data. The reason why the association is executed is that the operation data output from the controller 11 differs in an output timing of each production element in some cases, as described above. In the data collector 22a, ideal data (obtained from physical and chemical formulae), experimentally good data, or the like may be stored manually in addition to the operation data.

The data mapper 22b ascertains start and end of each production method from the operation data and divides the operation data into lot units of which a production method is a unit. The lot sorter 22c divides the operation data divided into the lot units by the data mapper 22b for each running condition (each running mode) in which a state of each production element is added. The sorting is executed for each of a plurality of items such as each reaction unit.

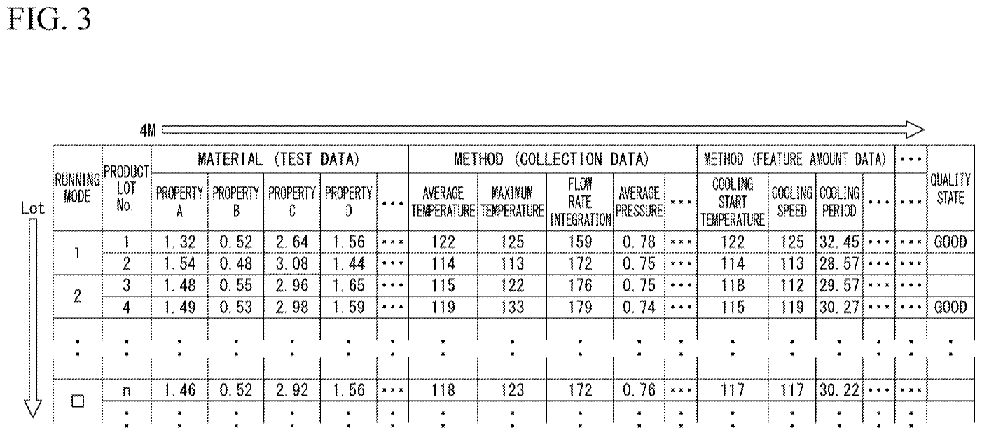

FIG. 3 is a diagram illustrating examples of the operation data sorted by the lot sorter of the performance ascertainer included in the design system unit. As illustrated in FIG. 3, the operation data includes operation data of each of the “four elements of production.” Specifically, operation data (test data) of “Material”, operation data (collection data or feature amount data) of “Method”, and the like are included. The operation data is divided for each lot (each product lot No.). The operation data divided for each lot is divided for each running mode (a condition of each production element). For example, in the example illustrated in FIG. 3, data of product lots No. 1 and 2 is sorted to “running mode 1” and data of product lots No. 3 and 4 is sorted to “running mode 2.”

As illustrated in FIG. 3, a column of a “quality state” is provided in the operation data divided for each lot. In this column, information indicating quality of a product for each lot can be stored after production of the product is completed. In the example illustrated in FIG. 3, “good” indicating that the quality of the product of the lot is good is stored in product lots No. 1 and 4.

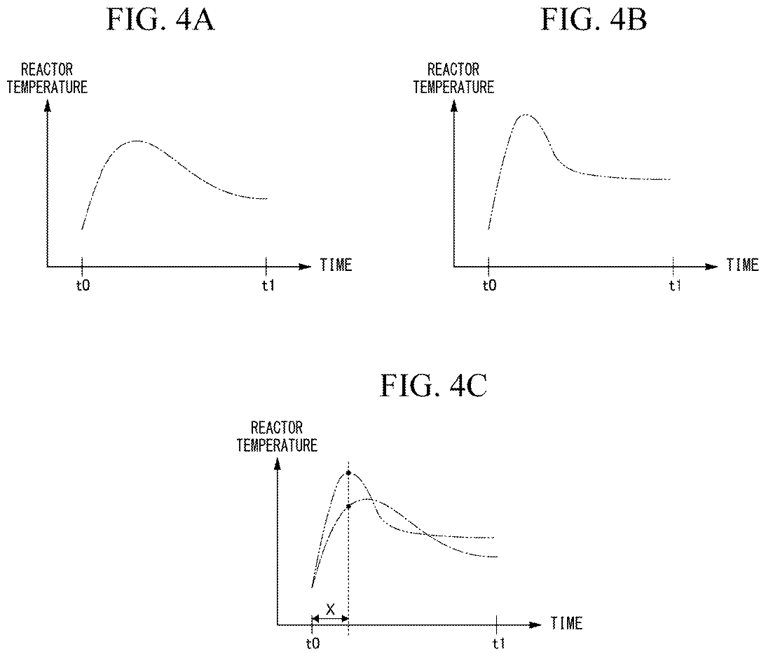

The feature amount extractor 22d extracts a feature amount indicating a time transition of the operation data in a section in which there is likelihood of an influence on the quality of the product from the operation data sorted for each running mode. FIGS. 4A to 4C are diagrams illustrating a process executed by the feature amount extractor of the performance ascertainer included in the design system unit. Here, an example of extraction of a feature amount from the operation data indicating a temporal change of a reactor temperature will be described.

The graph illustrated in FIG. 4A is a graph that shows a time transition of the operation data in a lot in which a product with good quality is obtained. The graph illustrated in FIG. 4B is a graph that shows a time transition of the operation data in a current lot (for example, a lot in which a product with poor quality is obtained). In the graphs of FIGS. 4A to 4C, time t0 indicates a time at which lot processing starts and time t1 indicates a time at which the lot processing ends.

As illustrated in FIG. 4C, the feature amount extractor 22d matches the time transition of the operation data in a current lot, as illustrated in FIG. 4B, and the time transition of the operation data in the lot in which a product with good quality is obtained, as illustrated in FIG. 4A with a time at which the lot processing starts to execute comparison. The feature amount extractor 22d indexes a section X in which transitions of the time transitions of the operation data are different and sets the time transitions of the operation data in the section X as a feature amount.

Here, the operation data of each of the “four elements of production” illustrated in FIG. 3 includes of data of 50 to 200 items. The feature amount extractor 22d narrows down the operation data to data of 10 to 20 items that have features. A veteran worker ascertains that a point in which a specific change of a certain process value occurs has an influence on quality in some cases. In these cases, a point designated by the veteran worker may be extracted as a feature amount. The feature amount extracted by the feature amount extractor 22d may be displayed so that the feature amount is used for improvement work.

As illustrated in FIG. 2B, the KPI generator 23 includes a similar lot extractor 23a, a standard lot setter 23b, and a comparison analyzer 23c. The similar lot extractor 23a extracts mutually similar lots based on the feature amount extracted by the performance ascertainer 22. Specifically, the similar lot extractor 23a extracts lots that have a similar or identical feature amount and have a “good” quality state (similar lots) from the lots of which the running modes are similar or identical. The number of lots (similar lots) extracted by the similar lot extractor 23a is, for example, about 40 to 50.

The standard lot setter 23b selects a standard lot serving as a standard from the lots extracted by the similar lot extractor 23a. Any method can be used as a method of selecting the standard lot. For example, the standard lot may be selected by narrowing down the lots by changing a weight for each production element (for example, a lot in which “Material” is similar other than “Machine” is preferred) so that a production PQCDS goal is realized. The production PQCDS is productivity, quality, cost, delivery, and safety.

The comparison analyzer 23c evaluates a relative difference by comparing a target lot with the standard lot selected by the standard lot setter 23b to evaluate the relative difference and generates the KPI 101 based on the difference. Here, a direct KPI or an indirect KPI can be used as the relative difference. The direct KPI is a KPI such as a particle size of a product that can be directly measured. The indirect KPI is a KPI for indirectly defining certain quality of an obtained product under production conditions of the product when the product with the quality is obtained. The indirect KPI is a KPI to which influences of a plurality of production elements are added as well as an influence of one production element and can serve as a knowledge which is a feature of a plant by cumulating (recording) the influences.

The comparison analyzer 23c evaluates the foregoing relative difference using, for example, a Mahalanobis-Taguchi (MT) method or multivariate analysis. When the comparison analyzer 23c executes the evaluation using the MT method and a Mahalanobis distance (MD) is equal to or less than a regular threshold (for example, MD<10), the difference (distance) is set as the KPI 101.

The KPI 101 set by the comparison analyzer 23c (the KPI 101 generated by the KPI generator 23) may be displayed on, for example, the interface 33. When the MD is greater than the regular threshold, the setting of the standard lot by the standard lot setter 23b or the extraction of the similar lots by the similar lot extractor 23a may be executed again and the evaluation may be executed again by the comparison analyzer 23c.

As illustrated in FIG. 2C, the OODA logic generator 24 includes a fault tree generator 24a (FT generator), an action list generator 24b, and an execution flowchart generator 24c. The FT generator 24a generates a fault tree (FT 102) used to estimate a cause of deterioration in quality of a product from the KPI 101 generated by the KPI generator 23. Here, a pre-generated fault tree of each production element may be stored. Hereinafter, this fault tree is referred to as an “original fault tree.” The FT generator 24a generates a fault tree obtained by correcting (improving) the original fault tree as the FT 102 in response to an instruction of a worker input from the interface 34 based on the KPI 101 generated by the KPI generator 23 using the original fault tree.

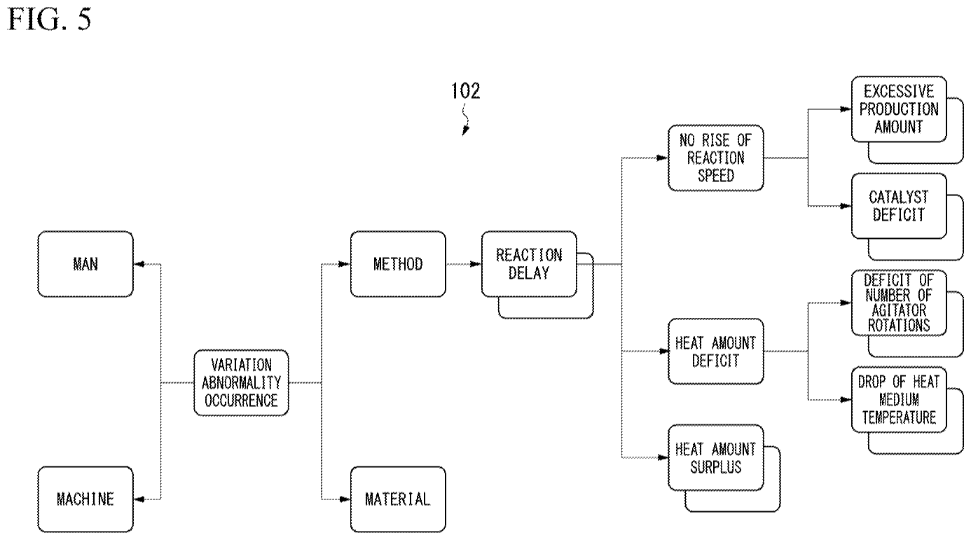

FIG. 5 is a diagram illustrating an example of a fault tree (FT) used in an embodiment of the present invention. The fault tree is generally information regarding a tree structure in which causes of generation of events are defined in a tree with regard to the events. In the example illustrated in FIG. 5, a cause of occurrence of an event such as “variation abnormality occurrence” of the quality of the product is defined for each of the “four elements of production” in a tree form with regard to this event. Only causes of “Method” are illustrated in FIG. 5 and causes in “Material,” “Machine,” and “Man” defined in the original fault tree are not illustrated. The FT 102 may include composite causes (causal relation) related to the plurality of production elements. That is, evaluation may be executed by adding states of the other production states to countermeasure methods (elements of the fault tree) at the time of drilling down the fault tree of a certain production element and a status may be displayed.

In the FT 102 exemplified in FIG. 5, “reaction delay” is exemplified as a cause of an event such as “variation abnormality occurrence” of the quality of product in “Method.” As causes of the “reaction delay,” three causes of “no rise of reaction speed,” “heat amount deficit,” and “heat amount surplus” can be exemplified. Further, as causes of “no rise of reaction speed,” two causes of “excessive production amount” and “catalyst deficient” can be exemplified. As causes of “heat amount deficit,” two causes of “deficit of number of agitator rotations” and “drop of heat medium temperature” can be exemplified. By using the FT 102, it is possible to estimate causes of deterioration in the quality of the product. A KPI to be checked may be added (displayed) to each element of the fault tree.

The action list generator 24b generates not only an action for achieving a goal but also the action list 103 in which measures for the production elements are suggested when the quality of the product deviates from the allowable range of the KPI 101. For example, the action list generator 24b generates the action list in response to an instruction of the worker input from the interface 34. The action list 103 can be a list in which actions of the worker to be executed so that the quality of the product deviating from the allowable range of the KPI 101 is within the allowable range of the KPI 101 again are defined. The action list 103 may include determination content from a managerial viewpoint (for example, cost is preferred, delivery (production amount) is preferred, or the like).

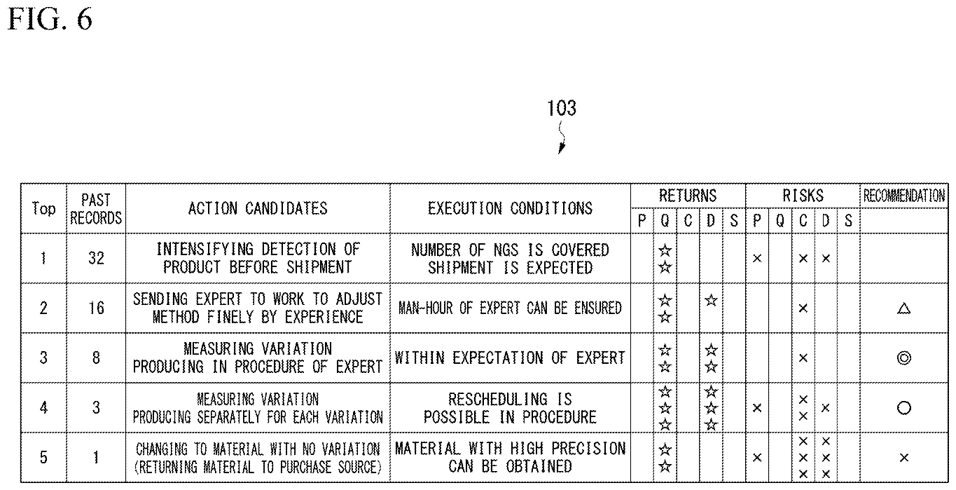

FIG. 6 is a diagram illustrating an example of an action list used in the embodiment of the present invention. The action list 103 exemplified in FIG. 6 is a list in which “past records,” “action candidates,” “execution conditions,” “returns (PQCDS),” “risks (PQCDS),” and “recommendation” are associated. In the “action candidates,” measures for the production elements (actions of a worker to be executed) are suggested. The “execution conditions” are conditions in which the associated “action candidates” are executed.

The “return (PQCDS)” is information indicating the PQCDS in which an improvement is expected when the associated “action candidate” is executed. The “risk (PQCDS)” is information indicating the PQCDS in which deterioration is expected when the associated “action candidate” is executed. The “recommendation” is information indicating the degree of recommendation of the associated “action candidate.” The “past records” indicates the number of times the associated “action candidate” is executed in the past. The action list 103 exemplified in FIG. 6 is sorted in order in which the “past records” is larger.

The execution flowchart generator 24c generates the flowchart 104 for executing measures for the production elements not only in a situation in which the quality of the product is stabilized but also in a case in which the quality of the product deteriorates (when the quality of the product deviates from the allowable range of the KPI 101). Specifically, the execution flowchart generator 24c generates a flowchart defined in a language in which the monitoring operator 12 (the operation executor 12b) of the execution system unit 10 can analyze the foregoing measures as the execution flowchart 104.

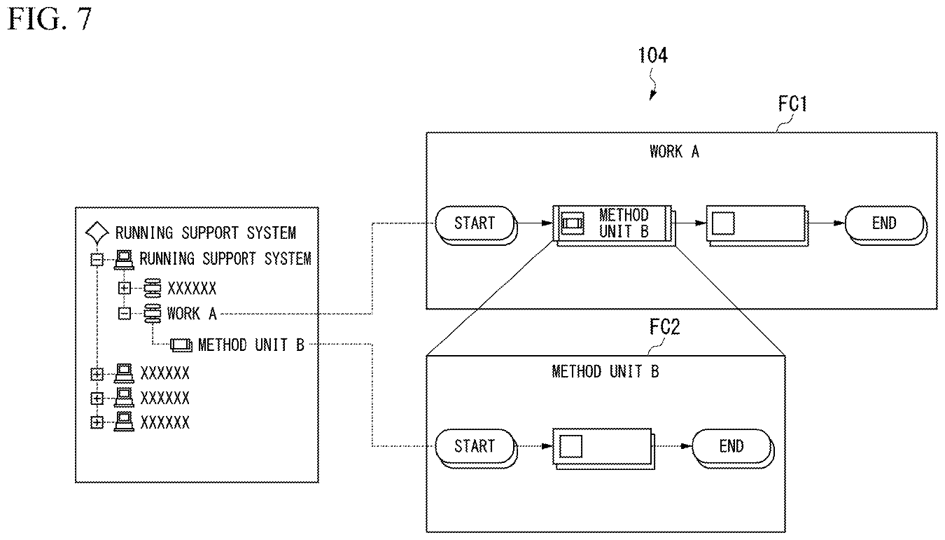

FIG. 7 is a diagram illustrating an example of an execution flowchart used in the embodiment of the present invention. The execution flowchart 104 exemplified in FIG. 7 includes an execution flowchart FC1 for “work A” which is executed in the running support system and an execution flowchart FC2 for “method unit B” included in “work A.” When the execution flowchart 104 is output to the execution system unit 10, the execution flowchart 104 is interpreted by the operation executor 12b of the monitoring operator 12, for example, in response to an instruction of the decision maker 13b and an instruction according to an instruction defined in the execution flowchart 104 is automatically executed to the controller 11.

As illustrated in FIG. 1, storages M1 to M4 are provided in the OODA logic generator 24. In the storage M1, the KPI 101 generated by the KPI generator 23 is stored. Specifically, in the storage M1, the KPI 101 is stored in association with a running mode and information regarding the standard lot or the like used to generate the KPI 101. In the storage M2, the above-described original fault tree and the FT 102 generated by the FT generator 24a are stored. In the storage M3, the action list 103 generated by the action list generator 24b is stored. In the storage M4, the execution flowchart 104 generated by the execution flowchart generator 24c is stored. In this way, by cumulating (storing) the OODA logic, it is possible to make knowledge as operation know-how of a plant.

### <Operation Example of Quality Stabilization System>

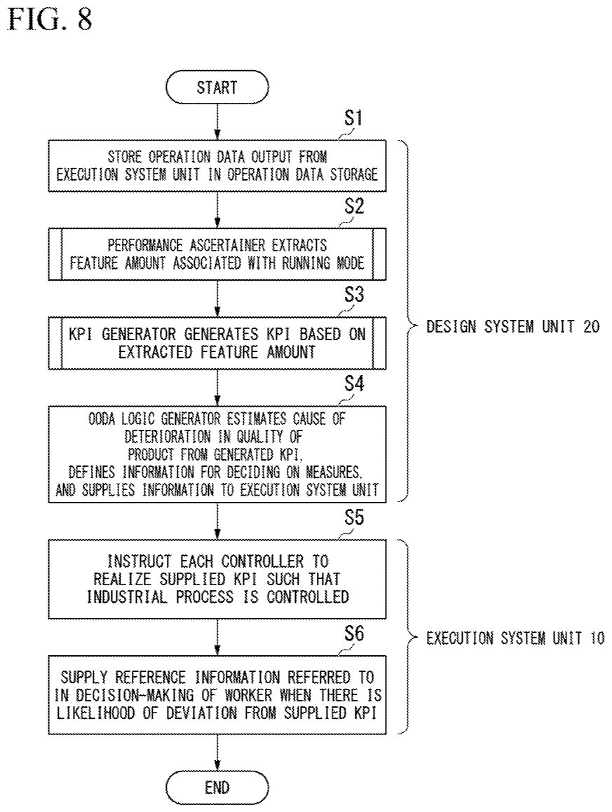

FIG. 8 is a flowchart illustrating an operation example of the quality stabilization system according to the embodiment of the present invention. In the flowchart illustrated in FIG. 8, the design system unit 20 executes processes of steps S1 to S4 and the execution system unit 10 executes processes of steps S5 and S6. FIG. 8 illustrates the flowchart in which, to facilitate understanding, the processes of steps S1 to S4 are executed, the processes of steps S5 and S6 are subsequently executed, and the series of processes ends. However, actually, the processes of steps S1 to S4 are executed periodically or aperiodically (for example, about once per month) and the processes of steps S5 and S6 are normally executed.

Here, in the quality stabilization system 1, the controller 11 provided in the execution system unit 10 normally collects the operation data apart from the processes of the flowchart illustrated in FIG. 8. Therefore, while the quality stabilization system 1 is operating, the operation data regarding the design system unit 20 is output from the controller 11 at a pre-defined timing. The controller 11 provided in the execution system unit 10 normally controls the production elements of a product produced in the industrial process IP.

In the flowchart illustrated in FIG. 8, when an operation of the design system unit 20 starts, a process of storing the operation data output from the execution system unit 10 in the operation data storage 21 is first executed (step S1). Subsequently, the performance ascertainer 22 executes a process of extracting a feature amount associated with a running mode (step S2: first step).

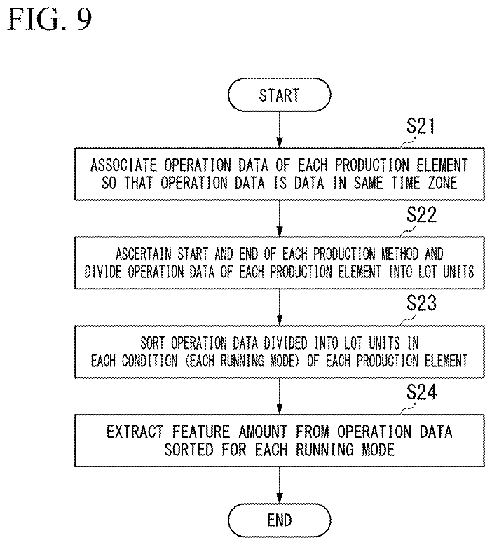

FIG. 9 is a flowchart illustrating details of a process executed in step S2 of FIG. 8. As illustrated in FIG. 9, in the process of step S2, the data collector 22a of the performance ascertainer 22 first executes a process of associating the operation data of each production element so that the operation data is data in the same time zone (step S21). By executing this process, the operation data can be associated as the data in the same time zone in the design system unit 20 even when the operation data of each production element is output at a different timing from the controller 11 of the execution system unit 10.

Subsequently, the data mapper 22b of the performance ascertainer 22 ascertains start and end of each production method from the operation data and executes a process of dividing the operation data into the lot units of which the production method is a unit (step S22). Subsequently, the lot sorter 22c executes the process of sorting the operation data divided into the lot units for each running condition (each running mode) to which a state of each production element is added (step S23). By executing the foregoing process, for example, it is possible to obtain the sorted operation data as illustrated in FIG. 3.

Subsequently, the feature amount extractor 22d of the performance ascertainer 22 executes the process of extracting the feature amount indicating the time transition of the operation data in the section in which there is likelihood of an influence on quality of a product from the operation data sorted for each running mode (step S24). For example, the feature amount extractor 22d executes a process of comparing the time transition of the operation data in the current lot with the time transition of the operation data in a lot in which a product with good quality is obtained, indexing a section in which the transition of the time transition of the operation data is different, and setting the time transitions of the operation data in the section as a feature amount.

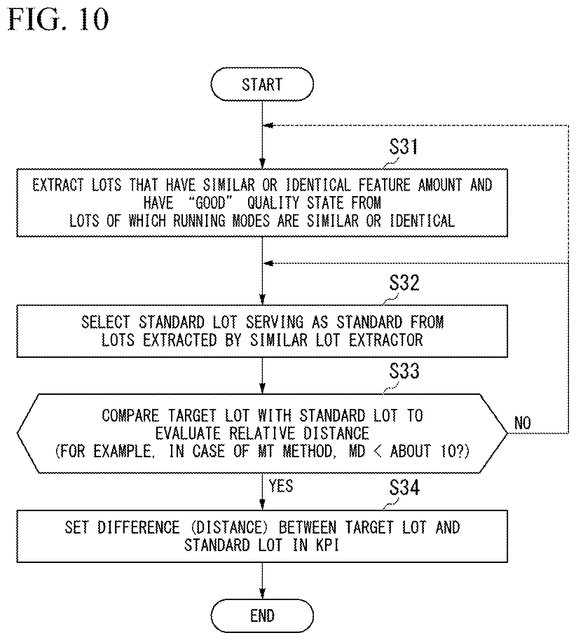

When the process of step S2 ends, the KPI generator 23 executes a process of generating the KPI 101 based on the extracted feature amount (step S3: first step). FIG. 10 is a flowchart illustrating details of a process executed in step S3 of FIG. 8. As illustrated in FIG. 10, in the process of step S3, the similar lot extractor 23a of the KPI generator 23 first executes a process of extracting lots that have a similar or identical feature amount and have a “good” quality state (similar lots) from the lots of which the running modes are similar or identical (step S31).

Subsequently, the standard lot setter 23b of the KPI generator 23 executes a process of selecting a standard lot serving as a standard from the lots extracted by the similar lot extractor 23a (step S32). For example, the standard lot setter 23b executes a process of selecting the standard lot by changing a weight for each production element (for example, a lot in which “Material” is similar other than “Machine” is preferred) and narrowing down the lots so that a production PQCDS goal is realized.

Subsequently, the comparison analyzer 23c of the KPI generator 23 executes a process of comparing a target lot with the standard lot selected by the standard lot setter 23b to evaluate the relative distance (step S33). For example, when the relative distance between the target lot and the standard lot is evaluated using the MT method, it is evaluated whether the Mahalanobis distance (MD) satisfies a relation of MD<about 10.

When the relative distance between the target lot and the standard lot is equal to or greater than a regulated value (for example, MD about 10), a determination result of step S33 is “NO” in the foregoing evaluation. Then, the standard lot setter 23b of the KPI generator 23 executes the process of setting the standard lot again (step S32). Alternatively, the similar lot extractor 23a of the KPI generator 23 executes a process of extracting the similar lots again (step S31), and then the standard lot setter 23b of the KPI generator 23 executes the process of the standard lot again (step S32).

Conversely, when the relative distance between the target lot and the standard lot is equal to or smaller than the regulated value (for example, MD<about 10), a determination result of step S33 is “YES.” Then, the comparison analyzer 23c of the KPI generator 23 executes the process of setting the difference (distance) between the target lot and the standard lot in the KPI 101 (step S34). The KPI 101 set by the comparison analyzer 23c is output to the OODA logic generator 24 and is stored in the storage M1 of the OODA logic generator 24.

When the process of step S3 ends, the OODA logic generator 24 executes the process of defining the OODA logic for guaranteeing quality from the generated KPI 101. Here, when the quality of a product deteriorates, the OODA logic generator 24 executes a process of estimating a cause of the deterioration in the quality of the product and defining the OODA logic necessary to decide on measures for the production elements (step S4: first step). Specifically, the OODA logic generator 24 executes a process of defining the KPI 101 generated by the KPI generator 23, the FT 102, the action list 103, and the execution flowchart 104 as the OODA logic.

For example, the FT generator 24a of the OODA logic generator 24 generates the FT 102 by correcting (improving) the original fault tree stored in the storage M2 based on the KPI 101 generated by the KPI generator 23 in response to an instruction of the worker input from the interface 34. For example, the action list generator 24b of the OODA logic generator 24 generates the action list 103 in response to an instruction of the worker input from the interface 34. For example, the execution flowchart generator 24c of the OODA logic generator 24 generates the execution flowchart 104 in response to an instruction of the worker input from the interface 34.

The OODA logic defined by the OODA logic generator 24 is supplied from the design system unit 20 to the execution system unit 10. For example, the KPI 101 and the execution flowchart 104 included in the OODA logic are supplied to the monitoring operator 12 of the execution system unit 10, and the FT 102 and the action list 103 included in the OODA logic are supplied to the decision-making supporter 13 of the execution system unit 10.

In the flowchart illustrated in FIG. 8, when an operation of the execution system unit 10 starts, the operation executor 12b of the monitoring operator 12 instructs the controller 11 (the controllers 11a to 11d) to realize the KPI 101 supplied from the design system unit 20 such that the industrial process IP is controlled (step S5). By making this instruction, the “four elements of production” are individually controlled.

While the industrial process IP is controlled, control according to the goal is automatically executed. The monitor 12a of the monitoring operator 12 normally monitors the operation data output from the controller 11. Then, the monitor 12a detects whether the quality of product obtained from the operation data is likely to deviate from the allowable range of the KPI 101 output from the design system unit 20. When it is detected that the quality of the product is likely to deviate from an allowable range of the KPI 101 output from the design system unit 20, a warning signal is output from the monitor 12a to the cause checker 13a of the decision-making supporter 13.

When the warning signal is output, the cause checker 13a of the decision-making supporter 13 executes a process of estimating a cause of deterioration in the quality of the product (a cause of the deviation in the quality of the product from the allowable range of the KPI 101 output from the design system unit 20) using the FT 102 output from the design system unit 20. Here, a plurality of causes of the deterioration in the quality of the product may be estimated and displayed in order in which the likelihood of the plurality of estimated causes is higher. For example, of four causes of “excessive production amount,” “catalyst deficient,” “deficit of number of agitator rotations,” and “drop of heat medium temperature” shown in the FT 102 illustrated in FIG. 5, a case in which “the likelihood of “excessive production amount” is the highest and the likelihood of “drop of heat medium temperature” is the second highest may be displayed.

Subsequently, the decision maker 13b executes a process of supplying reference information which is referred to in decision-making of the worker based on the action list 103 output from the design system unit 20 (step S6: second step). For example, of the “action candidates” shown in the action list 103 illustrated in FIG. 6, a recommended item (“Sending expert to work to adjust method finely by experience,” “Producing in procedure of expert measuring variation,” or “Measuring variation and producing separately for each variation”) is supplied as the reference information.

The reference information supplied from the decision maker 13b is displayed on, for example, the interface 32. Here, o rather than supplying only the reference information, the decision maker 13b may give an instruction to the operation executor 12b and the operation executor 12b of the monitoring operator 12 may be caused to execute the execution flowchart 104 supplied from the design system unit 20.

### Mounting Example

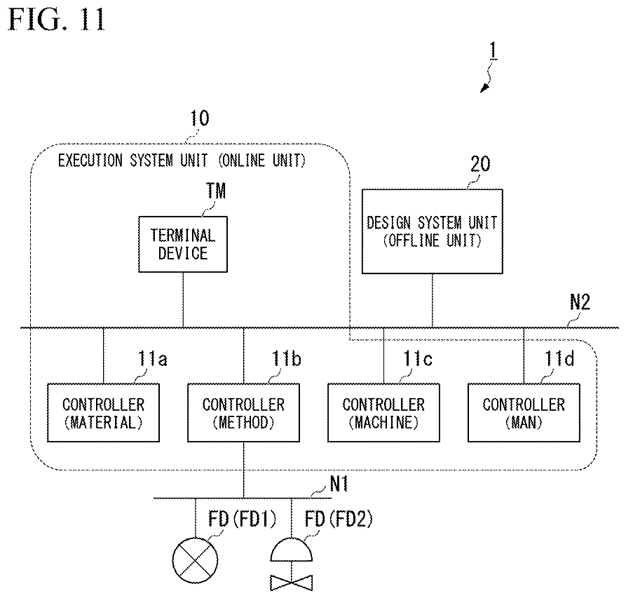

FIG. 11 is a block diagram illustrating an example of implementation of the quality stabilization system according to the embodiment. In FIG. 11, the same reference signs are given to blocks equivalent to the configuration illustrated in FIG. 1. As illustrated in FIG. 11, the execution system unit 10 and the design system unit 20 included in the quality stabilization system 1 are placed in higher positions of field devices FD.

The field devices FD are, for example, sensor devices such as a flowmeter and a temperature sensor, valve devices such as a flow control valve and an on-off valve, actuator devices such as a fan or a motor, and other devices installed in a field of a plant. In FIG. 11, to facilitate understanding, only one sensor device FD1 measuring a flow rate of fluid and only one valve device FD2 controlling (operating) a flow rate of fluid are illustrated among a plurality of field devices FD installed in a plant.

Examples of the plant in which the field devices FD are installed include not only an industrial plant such as a chemical plant but also a plant that manages and controls a well site such as a gas field or an oil field and the periphery of the well site, a plant such as that manages and controls power generation of a hydro-power, thermal power, nuclear power, or the like, a plant that manages and controls environmental power such as solar light or wind power, and a plant that manages and controls water supply and sewerage or a dam. The foregoing plants are merely exemplary and it is noted that the present invention is not limited to the foregoing plants.

The execution system unit 10 includes the controllers 11a to 11d and a terminal device TM. The controllers 11a to 11d are provided in the controller 11 illustrated in FIG. 1. The terminal device TM is a device that has the functions of the monitoring operator 12 and the decision-making supporter 13 illustrated in FIG. 1. The terminal device TM may have the functions of the interfaces 31 and 32 illustrated in FIG. 1. The terminal device TM is realized by, for example, a computer such as a personal computer or a workstation.

The design system unit 20 has the functions of the operation data storage 21, the performance ascertainer 22, the KPI generator 23, and the OODA logic generator 24 illustrated in FIG. 1. The design system unit 20 may have the functions of the interfaces 31 and 32 illustrated in FIG. 1. The design system unit 20 is realized by, for example, a computer such as a personal computer or a workstation as in the terminal device TM.

The field devices FD and the controller 11b are connected to each other via a network N1. The controllers 11a to 11d, the terminal device TM, and the design system unit 20 are connected to each other via a network N2. The network N1 is, for example, a wired network lain in a field of a plant. On the other hand, the network N2 is, for example, a wired network connecting the field of the plant to a monitoring room. The networks N1 and N2 may be wireless networks.

Data (for example, data indicating a measurement result of a flow rate of fluid) obtained by the sensor device FD1 is output to the controller 11b via the network N1. Data (for example, data for controlling a flow rate of fluid) generated by the controller 11b is output to the valve device FD2 via the network N1. The operation data collected by the controllers 11a to 11d is output to the terminal device TM and the design system unit 20 via the network N2.

The OODA logic defined by the design system unit 20 is supplied to the terminal device TM via the network N2. To realize the KPI 101 included in the OODA logic supplied from the design system unit 20, instructions for the controllers 11a to 11d are output from the terminal device TM via the network N2. Thus, the “four elements of production” are individually controlled.

Here, the terminal device TM executes a process of estimating a cause of deterioration in quality of a product using the FT 102 included in the OODA logic when it is detected that the quality of product is likely to deviate from the allowable range of the KPI 101 output from the design system unit 20. Then, the terminal device TM executes a process of supplying reference information which is referred to in decision-making of a worker based on the action list 103 included in the OODA logic.

As described above, in the embodiment, the design system unit 20 extracts a feature amount indicating a time transition of the operation data in a section in which there is likelihood of an influence on quality of a product from the operation data which is data related to the plurality of production elements of the product, generates the KPI 101 for evaluating the quality of the product based on the feature amount, and defines the OODA logic necessary to estimate a cause of deterioration in the quality of the product and decide on measures for the production elements from the KPI 101. The execution system unit 10 monitors and operates the plurality of production elements in real time according to the OODA loop using the defined OODA logic. Thus, it is possible to stabilize quality of a product despite large variations in production elements. As a result, it is possible to produce the product with higher quality at lower cost.

The quality stabilization system and the quality stabilization method according to the embodiment of the present invention have been described above, but the present invention is not limited to the foregoing embodiment and can be modified freely within the scope of the present invention. For example, FIG. 11 illustrates the example in which the terminal device TM of the execution system unit 10 and the design system unit 20 are configured as separate devices, but the terminal device TM of the execution system unit 10 and the design system unit 20 may be realized by one device.

The quality stabilization system 1 may be realized by cloud computing. Here, for example, the cloud computing may coincide with definition (definition recommended by the National Institute of Standard and Technology) described documents specified in the following uniform resource locator (URL):

http://nvlpubs.nist.gov/nistpubs/Legacy/SP/nistspecialpublication800-145.pdf; and

https://www.ipa.go.jp/files/000025366.pdf.

The quality stabilization system 1 may cooperate with another production system different from a production system realized in the industrial process IP. For example, the quality stabilization system 1 may cooperate with production systems that produce materials used in the industrial process IP. In this example, when it is determined that it is appropriate to change a blend ratio of materials used in the industrial process IP, the quality stabilization system 1 can change the blend ratio of the materials used in the industrial process IP by giving instructions to controllers of the other production systems.

In the foregoing embodiment, the standard lot setter 23b of the KPI generator 23 selects the standard lot serving as the standard from the lots extracted by the similar lot extractor 23a, as described above. That is, the standard lot setter 23b selects the standard lot from the lots that have a similar or identical feature amount and have a “good” quality state. However, when the standard lot setter 23b selects the standard lot, the standard lot may be selected in consideration of a detection ratio or an error detection ratio.

Here, the detection ratio is a ratio (an ideal ratio is 100%) of lots determined to be definitely poor among the lots in which the quality of the product is poor. The error detection ratio is a ratio (an ideal ratio is 0%) of lots in which the quality is good among the lots in which it is determined that the quality of the product is poor.

When a lot closest to a plurality of lots in which the quality state is “good” is selected as the standard lot, the detection ratio increases. However, there is likelihood of quality being pulled to quality of the lot serving as the standard lot. On the other hand, when a lot close to an average of a plurality of lots in which the quality state is “good” is selected as the standard lot, there is likelihood of the error detection ratio increasing. In this way, a function of narrowing down the standard lot based on balance of the error detection ratio or the detection ratio may be provided.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

### Supplementary Note

According to an aspect of the present invention, there is provided a quality stabilization system including: a design system unit (20) configured to extract a feature amount indicating a time transition of operation data which is data related to a plurality of production elements of a product in a section in which there is likelihood of an influence on quality of the product from the operation data, generate an evaluation index (101) for evaluating the quality of the product based on the feature amount, and define running maintenance improvement information necessary to estimate a cause of deterioration in the quality of the product and decide on measures for the production elements from the evaluation index; and an execution system unit (10) configured to monitor the operation data related to the product to be produced and supply reference information referred to in decision-making of a worker participating in production of the product using the running maintenance improvement information defined by the design system unit when the execution system unit has detected that the quality of the product is likely to deviate from an allowable range of the evaluation index.

In the quality stabilization system according to the aspect of the present invention, the design system unit may include an extractor (22) configured to extract the feature amount from the operation data, an evaluation index generator (23) configured to generate the evaluation index based on the feature amount, and a definer (24) configured to define the running maintenance improvement information from the evaluation index.

In the quality stabilization system according to the aspect of the present invention, the extractor includes a data collector (22a) configured to collect the operation data, a data mapper (22b) configured to ascertain start and end of each production method from the operation data and dividing the operation data into lot units of which a production method is a unit, a lot sorter (22c) configured to sort the operation data divided into the lot units for each running mode, and a feature amount extractor (22d) configured to extract the feature amount from the operation data sorted for each running mode.

In the quality stabilization system according to the aspect of the present invention, the evaluation index generator includes a similar lot extractor (23a) configured to extract mutually similar lots based on the feature amount, a standard lot setter (23b) configured to select a standard lot serving as a standard from the lots extracted by the similar lot extractor, and a comparison analyzer (23c) configured to compare a target lot with the standard lot to evaluate a relative difference and generate the evaluation index based on the difference.

In the quality stabilization system according to the aspect of the present invention, the definer includes a storage (M1) configured to store the generated evaluation index, a fault tree generator (24a) configured to generate a fault tree (102) used to estimate a cause of deterioration in the quality of the product from the evaluation index, an action list generator (24b) configured to generate an action list (103) for proposing measures for the production elements when the deviation from the allowable range of the evaluation index occurs, and an execution flowchart generator (24c) configured to generate an execution flowchart (104) for executing the measures.

In the quality stabilization system according to the aspect of the present invention, the execution system unit gives an instruction in accordance with the execution flowchart to a plurality of control devices (11a to 11d) controlling the production elements.

In the quality stabilization system according to the aspect of the present invention, the execution system unit gives an instruction to the plurality of control devices (11a to 11d) controlling the production elements so that the quality of the product is within an allowable range of the evaluation index.

According to another aspect of the present invention, there is a quality stabilization method including: a first step (S2 to S4) of extracting, by a design system unit (20), a feature amount indicating a time transition of operation data which is data related to a plurality of production elements of a product in a section in which there is likelihood of an influence on quality of the product from the operation data, generating, by a design system unit (20), an evaluation index (101) for evaluating the quality of the product based on the feature amount, and defining, by a design system unit (20), running maintenance improvement information necessary to estimate a cause of deterioration in the quality of the product and decide on measures for the production elements from the evaluation index; and a second step (S6) of monitoring, by an execution system unit (10), the operation data related to the product to be produced and supplying, by an execution system unit (10), reference information referred to in decision-making of a worker participating in production of the product using the running maintenance improvement information defined by the first step when the execution system unit (10) has detected that the quality of the product is likely to deviate from an allowable range of the evaluation index.

As used herein, the following directional terms “front, back, above, downward, right, left, vertical, horizontal, below, transverse, row and column” as well as any other similar directional terms refer to those instructions of a device equipped with the present invention. Accordingly, these terms, as utilized to describe the present invention should be interpreted relative to a device equipped with the present invention.

The term “configured” is used to describe a component, unit or part of a device includes hardware and/or software that is constructed and/or programmed to carry out the desired function.

Moreover, terms that are expressed as “means-plus function” in the claims should include any structure that can be utilized to carry out the function of that part of the present invention.

The term “unit” is used to describe a component, unit or part of a hardware and/or software that is constructed and/or programmed to carry out the desired function. Typical examples of the hardware may include, but are not limited to, a device and a circuit.

While preferred embodiments of the present invention have been described and illustrated above, it should be understood that these are examples of the present invention and are not to be considered as limiting. Additions, omissions, substitutions, and other modifications can be made without departing from the scope of the present invention. Accordingly, the present invention is not to be considered as being limited by the foregoing description, and is only limited by the scope of the claims.

What is claimed is:

1. A quality stabilization system comprising:
a design system unit configured to extract a feature amount indicating a time transition of operation data which is data related to a plurality of production elements of a product in a section in which there is likelihood of an influence on quality of the product from the operation data, generate an evaluation index for evaluating the quality of the product based on the feature amount, and define running maintenance improvement information necessary to estimate a cause of deterioration in the quality of the product and decide on measures for the production elements from the evaluation index; and
an execution system unit configured to monitor the operation data related to the product to be produced and supply reference information referred to in decision-making of a worker participating in production of the product using the running maintenance improvement information defined by the design system unit when the execution system unit has detected that the quality of the product is likely to deviate from an allowable range of the evaluation index.

2. The quality stabilization system according to claim 1,
wherein the design system unit comprises:
an extractor configured to extract the feature amount from the operation data;
an evaluation index generator configured to generate the evaluation index based on the feature amount; and
a definer configured to define the running maintenance improvement information from the evaluation index.

3. The quality stabilization system according to claim 2,
wherein the extractor comprises:
a data collector configured to collect the operation data;
a data mapper configured to ascertain start and end of each production method from the operation data and divide the operation data into lot units of which a production method is a unit;
a lot sorter configured to sort the operation data divided into the lot units for each running mode; and
a feature amount extractor configured to extract the feature amount from the operation data sorted for each running mode.

4. The quality stabilization system according to claim 2,
wherein the evaluation index generator comprises:
a similar lot extractor configured to extract mutually similar lots based on the feature amount;
a standard lot setter configured to select a standard lot serving as a standard from the lots extracted by the similar lot extractor; and
a comparison analyzer configured to compare a target lot with the standard lot to evaluate a relative difference and generate the evaluation index based on the difference.

5. The quality stabilization system according to claim 2,
wherein the definer comprises:
a storage configured to store the generated evaluation index;
a fault tree generator configured to generate a fault tree used to estimate a cause of deterioration in the quality of the product from the evaluation index;
an action list generator configured to generate an action list for proposing measures for the production elements when the deviation from the allowable range of the evaluation index occurs; and
an execution flowchart generator configured to generate an execution flowchart for executing the measures.

6. The quality stabilization system according to claim 5,
wherein the execution system unit gives an instruction in accordance with the execution flowchart to a plurality of control devices controlling the production elements.

7. The quality stabilization system according to claim 1,
wherein the execution system unit gives an instruction to a plurality of control devices controlling the production elements so that the quality of the product is within the allowable range of the evaluation index.

8. The quality stabilization system according to claim 5,
wherein the execution system unit comprises:
a controller configured to control the production elements and output the operation data;
a monitoring operator configured to monitor the operation data output from the controller and output a warning signal when the monitoring operator has detected that the quality of the product is likely to deviate from the allowable range of the evaluation index; and
a decision-making supporter configured to supply the reference information when the warning signal has been output from the monitoring operator.

9. The quality stabilization system according to claim 8,
wherein the monitoring operator comprises:
a monitor configured to output the warning signal; and
an operation executor configured to give an instruction to the controller so that the quality of the product is within the allowable range of the evaluation index.

10. The quality stabilization system according to claim 9,
wherein the decision-making supporter comprises:
a cause checker configured to estimate a cause of deterioration in the quality of the product when the warning signal has been output from the monitor; and
a decision maker configured to supply the reference information based on the cause estimated by the cause checker.

11. The quality stabilization system according to claim 9,
wherein the operation executor gives the instruction according to the execution flowchart generated by the execution flowchart generator to the controller.

12. The quality stabilization system according to claim 10,
wherein the cause checker estimates the cause of deterioration in the quality of the product using the fault tree generated by the fault tree generator.

13. The quality stabilization system according to claim 10,
wherein the decision maker supplies the reference information based on the action list generated by the action list generator.

14. A quality stabilization method comprising:
a first step of extracting, by a design system unit, a feature amount indicating a time transition of operation data which is data related to a plurality of production elements of a product in a section in which there is likelihood of an influence on quality of the product from the operation data, generating, by the design system unit, an evaluation index for evaluating the quality of the product based on the feature amount, and defining, by the design system unit, running maintenance improvement information necessary to estimate a cause of deterioration in the quality of the product and decide on measures for the production elements from the evaluation index; and
a second step of monitoring, by an execution system unit, the operation data related to the product to be produced and supplying, by the execution system unit, reference information referred to in decision-making of a worker participating in production of the product using the running maintenance improvement information defined by the first step when the execution system unit has detected that the quality of the product is likely to deviate from an allowable range of the evaluation index.

15. The quality stabilization method according to claim 14, further comprising:
extracting, by the design system unit, the feature amount from the operation data;
generating, by the design system unit, the evaluation index based on the feature amount; and
defining, by the design system unit, the running maintenance improvement information from the evaluation index.

16. The quality stabilization method according to claim 15, further comprising:
collecting the operation data by the design system unit;
ascertaining, by the design system unit, start and end of each production method from the operation data;
dividing, by the design system unit, the operation data into lot units of which a production method is a unit;
sorting, by the design system unit, the operation data divided into the lot units for each running mode; and
extracting, by the design system unit, the feature amount from the operation data sorted for each running mode.

17. The quality stabilization method according to claim 15, further comprising:
extracting, by the design system unit, mutually similar lots based on the feature amount;
selecting, by the design system unit, a standard lot serving as a standard from the lots which has been extracted;
comparing, by the design system unit, a target lot with the standard lot to evaluate a relative difference; and
generating, by the design system unit, the evaluation index based on the difference.

18. The quality stabilization method according to claim 15, further comprising:
storing, by the design system unit, the generated evaluation index;
generating, by the design system unit, a fault tree used to estimate a cause of deterioration in the quality of the product from the evaluation index;
generating, by the design system unit, an action list for proposing measures for the production elements when the deviation from the allowable range of the evaluation index occurs; and
generating, by the design system unit, an execution flowchart for executing the measures.

19. The quality stabilization method according to claim 18, further comprising:
giving, by the execution system unit, an instruction in accordance with the execution flowchart to a plurality of control devices controlling the production elements.

20. The quality stabilization method according to claim 14, further comprising:
giving, by the execution system unit, an instruction to a plurality of control devices controlling the production elements so that the quality of the product is within the allowable range of the evaluation index.
